(19) United States
(12) Patent Application Publication
(10) Pub. No.: US 2009/0114859 A1
(43) Pub. Date: May 7, 2009

(54) Use of ZnO Nanocrystals For Imaging and Therapy

(76) Inventors: Paras Prasad, Williamsville, NY (US); Aliaksandr Kachynski, Amherst, NY (US); Andrey Kuzmin, Amherst, NY (US); Marcin Nyk, Buffalo, NY (US); Indrajit Roy, Amherst, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/140,011

(22) Filed: Jun. 16, 2008

Related U.S. Application Data
(60) Provisional application No. 60/934,848, filed on Jun. 15, 2007.

(51) Int. Cl. G01N 23/04

(52) U.S. Cl. 250/580

(57) ABSTRACT

The present invention provides a method for imaging a biological specimen using non-linear optical properties of certain materials. The method comprises the steps of providing an aqueous dispersion of ZnO nanocrystals; contacting a biological specimen with an aqueous dispersion comprising ZnO nanocrystals; exposing the biological specimen to input electromagnetic radiation having a wavelength of from 600 to 1500 nm; recording the nonlinear output electromagnetic radiation; and generating an image of the biological specimen based on the nonlinear output radiation.

This application claims priority to U.S. Provisional Application No. 60/934,848, filed on Jun. 15, 2007, the disclosure of which is incorporated herein by reference.

This invention was supported by funding from the U.S. Air Force Office of Scientific Research (AFOSR) under grant number is FA95500610398. The Government has certain rights in the invention.

### FIELD OF THE INVENTION

This invention relates generally to imaging of living tissues and more particularly provides compositions and methods for nonlinear optical imaging of cells and tissues.

### BACKGROUND OF THE INVENTION

Optical imaging is a promising technique in the study of living organisms due to its high resolution and ability to detect targets at the molecular level. However, a number of technical impediments limit its scope in biological applications. These impediments include fluorescence photobleaching, invariable range of excitation and emission wavelengths, narrow difference between excitation and emission spectra, broad emission of small molecule fluorophores, potential toxicity of labeled organic fluorophores or heavy-metal based semiconductor nanocrystals (such as CdS quantum dots), and above all, limited penetration of visible light through biological tissues.

Biological samples can be optically imaged via fluorescence imaging using contrast agents. However, the use of fluorescence contrast agents such as organic dyes can have a number of known drawbacks, such as weak photostability, and broad absorption and emission bands. Semiconductor nanocrystals, such as CdS nanocrystals, are still controversial due to their inherent toxicity and chemical instability, even though they exhibit high photostability, size-dependent and narrow emissions and high quantum yields.

Materials with nonlinear optical properties can be used as contrast agents. A number of nonlinear optical processes such as two- (or multi-) photon excited fluorescence (TPEF), second- and third-harmonic generation (SHG and THG), and vibration coherent anti-Stokes Raman scattering (CARS) have been used for live cells and tissue imaging. The most commonly used nonlinear optical process in bioimaging is two-photon excited fluorescence, which is a resonant process. However, it requires an efficient two-photon excitation limited to a specific wavelength, which corresponds to the two-photon resonance of the dye. In addition, because of its resonant nature, the dye is susceptible to photobleaching. The use of second-order processes (SHG, SFG) has been limited to, in general, component materials with centrally symmetrical unit cell structure result in limited SHG output of from the interface layers, low contrast and image quality.

Based on the foregoing, there is an ongoing, unmet need for contrast agents that can generate within a sample, i.e. in situ, new wavelengths useful for imaging biological samples and/or for therapeutic applications.

### SUMMARY OF THE INVENTION

The present method provides an imaging method based on the nonlinear optical properties of ZnO nanocrystals which results in use of incident electromagnetic radiation that is not absorbed to any significant extent by the sample. ZnO nanocrystals with a crystal structure based on non-centrosymmetric space group demonstrate second- and third-order nonlinear optical properties and are suitable for the present method.

In the method of the present invention, a biological specimen is contacted with an aqueous dispersion comprising ZnO nanocrystals. The specimen is then exposed to input electromagnetic radiation having a wavelength of from 600 to 1500 nm and the nonlinear output electromagnetic radiation is recorded. The nonlinear output radiation is then used to generate an image of the specimen.

In one embodiment, the ZnO nanocrystals can be conjugated to specific affinity molecules to provide targeting imaging capability.

### BRIEF DESCRIPTION OF THE DRAWINGS

FIG. 1. TEM images of ZnO nanocrystals.

FIG. 2. Graphical representation of x-ray diffraction spectrum of ZnO nanocrystals.

FIG. 3(a). Schematic of optical set-up for nonlinear optical microscopy imaging using ZnO nanocrystals.

FIG. 3(b). Schematic of specific embodiment of optical set-up for nonlinear optical microscopy imaging using ZnO nanocrystals.

FIG. 4. Charged coupled device (CCD)-camera images of ZnO water-dispersed nanocrystals under focused beam illumination.

FIG. 5. Graphical representation of new frequencies generated by irradiation of water-dispersed ZnO nanocrystals.
(a)—ν₁=8516 angstroms and ν₂=10640 angstroms generate SFG wave at 4727 angstroms and two SHG wave at 4253 angstroms and 5320 angstroms
(b)—ν₁=8542 angstroms and ν₂=10640 angstroms generate SFG wave at 4737 angstroms and two SHG wave at 4271 angstroms and 5320 angstroms
(c)—ν₁=8592 angstroms and ν₂=10640 angstroms generate SFG wave at 4753 angstroms and two SHG waves at 4296 angstroms and 5320 angstroms
(d)—ν₁=8506 angstroms and ν₂=10640 angstroms generate FWM wave at 7082 angstroms
   ν₁=8542 angstroms and ν₂=10640 angstroms generate FWM wave at 7132 angstroms
   ν₁=8592 angstroms and ν₂=10640 angstroms generate FWM wave at 7205 angstroms

FIG. 6. Images of human nasopharyngeal epidermal (KB) cells labeled by water-dispersed ZnO nanocrystals. Red color (in the original image, seen in the black & white image herein as white dots and indicated by arrows) represents a sum frequency generation (SFG) signal of 475 nm generated by nanocrystals on irradiation by ν1=859 nm and ν2=1064 nm.

FIG. 7. The sum frequency generation (SFG) and four-wave mixing (FWM) nonlinear optical images of treated KB cells treated with aqueous dispersions ZnO nanocrystals. The SFG images of KB cells treated with the ZnO nanocrystals, non-targeted (a,c) and targeted with folic acid (b,d), after 1 (a,b) and 3 (c,d) hours of incubation. The intensity-coded SFG images in color (see scale inset on panel d) were superimposed on the transmission 1064 nm green color background images. (e) FWM image without transmission background and (f) is the corresponding SFG image of KB cells. Arrows indicate the dots representing the nonlinear output from ZnO nanocrystal accumulation.

### DESCRIPTION OF THE INVENTION

The present invention provides a method for imaging of biological specimens based on the use of nonlinear optical imaging using aqueous dispersions comprising zinc oxide (ZnO) nanocrystals. The steps of the method comprise: providing an aqueous dispersion comprising ZnO nanocrystals; contacting a biological specimen with the aqueous dispersion; exposing the biological specimen to input electromagnetic radiation; recording the nonlinear output electromagnetic radiation from the biological specimen; and generating an image of the biological specimen from the nonlinear the output electromagnetic radiation.

Any synthetic methodology that produces ZnO nanocrystals with the desired properties, for example size, crystal structure and morphology, can be used to generate ZnO nanocrystals useful in the present invention. Thus, ZnO nanocrystals useful in the present invention can be synthesized by non-hydrolytic sol-gel processes (see Example 1). The nanocrystals can also be synthesized by hydrothermal processes. The size range of useful ZnO nanocrystals for the present invention is from 5 nm to 500 nm. Preferably, the size range is from 50 nm to 200 nm, and more preferably 100 nm or less, and even more preferably from 50 nm to 100 nm. Additionally, it is desirable to use ZnO nanocrystals with a narrow size distribution, because this results in a uniform nonlinear optical response. While it was observed that all nanocrystals in a composition were within the desired size range, compositions with a majority of the nanocrystals in the size range can be used. In various embodiments, 70, 75, 80, 85, 90, 91, 92, 93, 94, 95, 96, 97, 98, 99 and 100% of the nanocrystals fall within the size range. In one embodiment, at least 90% of the nanocrystals are in the range of 5 nm to 500 nm. The size of the ZnO nanocrystals is defined herein as the diameter of a circle/sphere circumscribing the nanocrystal.

The structure and morphology of the ZnO nanocrystals is also important. The ZnO nanocrystals should have a crystal structure based on a non-centrosymmetric space group. In one embodiment, ZnO nanocrystals with a crystal structure based on a hexagonal unit cell (wurtzite) are useful in the present invention. The morphology of the nanocrystals describes their higher order structure (i.e. the shape of the nanocrystals). Typically, the ZnO nanocrystals have a trigonal morphology.

The use of an aqueous dispersion of ZnO nanocrystals avoids use of organic solvents that can cause undesirable effects on biological specimens. Stable aqueous dispersions of ZnO nanocrystals were maintained for at least up to 14 days at 4 degrees Celsius without observation of noticeable precipitation.

In one embodiment, the aqueous dispersion of ZnO nanocrystals comprises ZnO nanocrystals incorporated into and/or within a surrounding layer. The surrounding layer can completely or partially encompass the ZnO nanocrystals. For example, the surrounding layer can be a micelle. Without intending to be bound by any particular theory, it is considered that any molecule or structure with a hydrophobic region (that can form an internal portion) and a hydrophilic region (that can form an external portion) can be used to generate aqueous dispersions of ZnO nanocrystals having a surrounding layer.

In one embodiment, a stable aqueous dispersion of ZnO nanocrystals useful in the present method can be formed by incorporating the ZnO nanocrystals within and/or in a phospholipid micelle (see Example 1). Phospholipids conjugated to monomethoxy poly(ethylene glycol) (PEG methoxy) are useful in forming micelles that can be used to for aqueous dispersions of ZnO nanocrystals. In one embodiment, 1,2-distearoyl-sn-glycero-3-phosphoethanolamine-N—[methoxy(polyethylene glycol)-2000] (ammonium salt) (DSPE-PEG(2000) methoxy) (available from Avanti Polar Lipids) is used to form an aqueous-dispersion of the ZnO nanocrystals. DSPE is 1,2-distearoyl-sn-glycero-3-phosphoethanolamine. PEG(2000) methoxy is methoxy(poly(ethylene glycol)) with a molecular weight of 2000 amu. In another embodiment, DSPE-PEG(2000) methoxy and 1,2-distearoyl-sn-glycero-3-phosphoethanolamine-N—[folate(polyethylene glycol)-2000] (ammonium salt) (DSPE-PEG(2000) folate (—FA)) (both available from Avanti Polar Lipids) are used to form an aqueous-dispersion of ZnO nanocrystals. DSPE-PEG(2000) FA has folic acid incorporated in the DSPE-PEG molecule. Other molecules useful for incorporating ZnO nanocrystals in micelles are methoxy (poly(ethylene glycol)) ceramides (for example, but not limited to, N-palmitoyl-sphingosine-1-[succinyl(methoxy(poly(ethylene glycol))750)]) and functionalized PEG lipids (for example, but not limited to, DSPE-PEG(2000) carboxylic acid; DSPE-PEG(2000) maleimide; DSPE-PEG(2000) PDP; DSPE-PEG(2000) amine; DSPE-PEG(2000) Biotin)).

The surrounding layer can also comprise surfactants (such as Tween-80 and aerosol-OT), pluronic micelles (such as poloxamers, poloxamines), block-copolymer micelles, silica or organically modified silica (such as ORMOSIL), mercapto acids with a hydrophilic acid group and a hydrophobic alkyl thiol group (such as mercapto acetic acid, mercaptopropionic acid, and mercaptosuccinic acid), or a polysaccharide (such as starch).

The surface of the ZnO nanocrystals can be modified or functionalized with molecules compatible with aqueous systems so that the ZnO nanocrystals are stably dispersed in aqueous systems. Additionally, other diagnostic, therapeutic, or biorecognition molecules can be conjugated to the ZnO nanocrystal surface in order to generate a multifunctional nanosystem that is capable to targeted diagnostic or therapeutic applications.

The aqueous composition useful for the present invention can further comprise: photosensitizers or gold nanoshells. Compositions comprising these components can be used in therapeutic applications.

The ZnO nanocrystals composition can also be formulated so that the composition targets a specific tissue or cell type within the biological sample. For example, the surrounding layer can comprise an affinity molecule for which another molecule in the biological sample has specific affinity. The affinity molecule can be incorporated in or attached to the surrounding layer. As another example, the ZnO nanocrystal surface can be conjugated (such as by covalent attachment) with cell-specific targeting molecule(s) to generate targeted cell imaging. Examples of specific targeting molecules include, but are not limited to, tumor specific proteins such as transferrin, monoclonal antibodies, and small peptides such as arginine-glycine-aspartic acid (RGD).

In one embodiment the affinity molecule is folic acid, which is attached by covalent linkage to the phospholipid that comprises the surrounding layer, that targets cells with folic acid receptors (see Example 3).

In the present invention, biological specimens are contacted with ZnO nanocrystals dispersed in aqueous solution to incorporate the ZnO nanocrystals into the biological specimen. Without intending to be bound by any particular theory, it is considered that each nanosized single crystal (ZnO nanocrystal) then operates like a multifunctional optical nonlinear converter. Biological specimens useful in the present invention include, but are not limited to, cells, tissues, tissue samples such as biopsies, bodily fluids (such as blood or saliva), and whole organs. As an illustration, individual human nasopharyngeal epidermal carcinoma (KB) cells have been imaged using the present method (see Example 4). It is expected that whole animals can also be imaged using the present invention.

The biological specimen can be contacted with the ZnO nanocrystals composition in a variety of modalities. Examples of contacting modalities include, but are not limited to, soaking or immersing the biological specimen in the composition, adding the composition to a cell culture medium and administering the composition to the sample (to effect either local or systemic contacting).

After contacting the biological specimen with the aqueous dispersion of ZnO nanocrystals, the biological specimen is exposed to electromagnetic radiation (input electromagnetic radiation). The source of the electromagnetic radiation can be a coherent light source, such as a laser. In one embodiment, the input electromagnetic radiation is high intensity laser radiation of picosecond (pulse width in between of 1 and 1000 picoseconds (ps)), or nanosecond (pulse width in between of 1 and 1000 nanoseconds (ns), or femtosecond (pulse width in between of 1 and 1000 femtoseconds (fs)) pulses. The wavelength of the input electromagnetic radiation can be from the visible to the near infrared (600 nm-1500 nm). It is preferable to use an input electromagnetic radiation that is in the window of maximum biological transparency (˜800 nm to 1.3 μm) to enhance penetration depth into the biological specimen. In one embodiment, a single wavelength of input electromagnetic radiation can be used. In another embodiment, two wavelengths are used. In one embodiment, the two wavelengths in the input electromagnetic radiation are selected from the following wavelengths: 851, 854, 859, 1064 nm. It is well known in the art that the wavelength of electromagnetic radiation is directly related to the frequency of the electromagnetic radiation.

The nonlinear optical properties of the ZnO nanocrystals allow use of incident electromagnetic radiation that is not absorbed by the sample. The; second- and third-order nonlinear optical properties of the ZnO nanocrystals converts the input electromagnetic radiation to nonlinear output electromagnetic radiation—in situ—generating the following new frequencies (a) second-harmonic generation (SHG) electromagnetic radiation at 2 ν₁ or/and 2 ν₂ frequencies, when irradiated with electromagnetic radiation of frequency ν₁ or/and ν₂; (b) (ν₁+ν₂) by sum frequency generation (SFG); and (c)—(2 ν₁−ν₂) by four-wave mixing (FWM), including Coherent anti-Stokes Raman Scattering (CARS) signal, when irradiated simultaneously with electromagnetic radiation of frequency ν₁ and ν₂. The production of new frequencies by the ZnO nanocrystals (nonlinear output electromagnetic radiation) can be used as a contrast mechanism to provide digital images by means of a detection and computation system.

In generating an image of a biological specimen, electromagnetic radiation of a single frequency (ν₁ or ν₂) or two beams together (ν₁ and ν₂) adjusted to be conjugated in space, time and spectrum, are focused and scanned in to the ZnO nanocrystal-treated biological sample. The nonlinear output electromagnetic radiation, which propagates both in the forward and backward directions with regards to the incident electromagnetic radiation (ν₁ and ν₂) (input electromagnetic radiation), is split by dichroic mirrors, filtered spectrally and spatially from the individual beams and directed to individual detector channels where it is recorded. After computing the data from different detectors, individual digital images corresponding to the nonlinear output optical frequencies represent a SHG signal image, or SFG signal image, or FWM signal image that reflects the ZnO nanocrystal distribution within the biological specimen. In the targeted imaging embodiment, the image generated from the nonlinear optical output electromagnetic radiation will reflect the ZnO nanocrystal distribution within the targeted areas of the biological specimen.

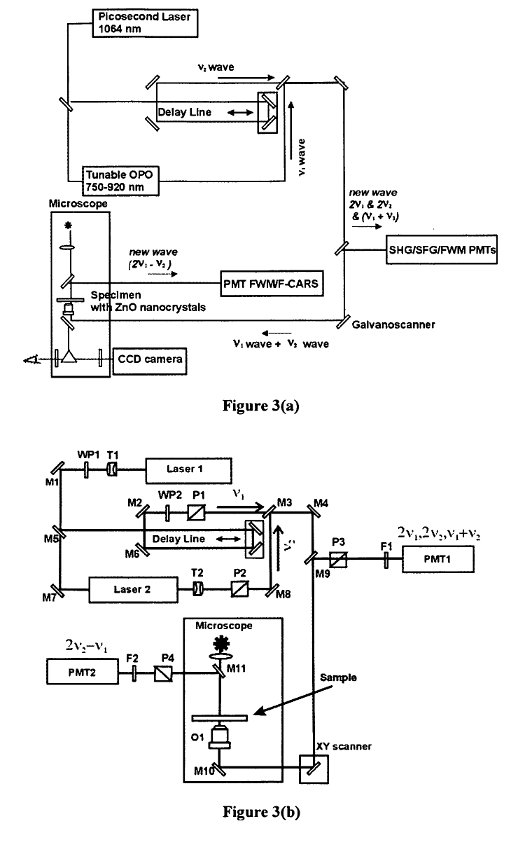

FIGS. 3(a) and 3(b) are schematic representations of imaging systems that can be used to practice the present invention. FIG. 3(a) depicts an optical setup of a laser scanning SHG/SFG/FWM imaging system. Laser 1 and Laser 2 are picosecond lasers with the outputs at ν₁ and ν₂, respectively; Microscope is an inverted or upright laser scanning microscope; and, PMT1, PMT2 are photomultiplier tubes. The optical Delay Line, the barrier filter wheels, F1 and F2, and the optical XY scanner are all computer controlled.

FIG. 3(b) depicts a specific embodiment of an imaging system. A picosecond diode pumped Nd:YVO4 laser (Laser 1) (picoTRAIN IC-10000 1064 nm (HighQ Laser), with a ˜10 ps pulse width and a repetition rate of 76 MHz) was used as a source for the ν1 incident wave. It also was used for synchronous pumping of Laser 2, a tunable (781-923 nm) optical parametric oscillator (Levante (APE)) used to produce another incident wave (ν2) of ˜10 ps pulse duration. Laser 1 and Laser 2 can be used separately for SHG signal generation of the sample. SFG and FWM signal generation require coherent mixing of ν1 and ν2 incident waves. For the coherent mixing process, computer controlled delay line provided temporal synchronization of picosecond pulses of Laser 1 and Laser 2 with a zero time jitter, and adjustable telescopes T1 and T2 ensured the beams focal point conjugation at the plane of the microscope specimen. Picosecond outputs of Laser 1 and Laser 2, coinciding in time and space, were directed to an inverted microscope (TE2000-S (Nikon)). A computer-controlled XY galvano scanner (VM1000 (GSI Lumonics)) insured fast scans along the sample in the lateral (XY) focal plane of the water-immersion objective (O1) (UPLSAPO 60XW, NA=1.2 (Olympus)). The O1 objective was mounted on a computer-controlled piezo-stage (Piezosystem (Jena)) for an axial laser beam Z-scanning through the sample, with the minimum step of 0.1 nm. Splitting power ratio of Laser 1 output between the pump power of Laser 2 and the ν1 incident wave was controlled by a half-wave (λ/2) waveplate, WP1. Polarizations of Laser 1 and Laser 2 were computer-controlled by rotating Glan-Thomson polarizers, P1 and P2, and a half-wave (λ/2) waveplate, WP2. The SHG/SFG signals generated in the specimen plane were detected by a photomultiplier tube (R928 (Hamamatsu Photonics)), PMT1, in the reflection geometry; the narrow-bandpass barrier filter, F1, cuts the fundamental frequencies, ν1 and ν2, and separates the 2ν1/2ν2 (SHG) or ν1+ν2 (SFG) signals. The FWM response at the 2ν2−ν1 frequency generated in the forward direction, spectrally separated from ν1 and ν2 by a dichroic mirror, M11, and a barrier filter, F2, was detected by a photomultiplier tube (R928 (Hamamatsu Photonics)), PMT2. Operation of the optical scanner and acquisition system ensures digitization of the nonlinear signal at new frequencies 2ν1, 2ν2, (ν1+ν2) and (2ν2−ν1) and generates the nonlinear optical images.

The present invention includes applications for light-activated therapies using the nonlinear optical phenomena of SHG, SFG and FWM. One example of a ZnO nanocrystal based light-activated therapy is based on generating new frequencies of SHG or SFG signals in a specific spectral range by biological specimen illumination with tunable ν₁ or ν₂ electromagnetic radiation. Therapeutic action can be achieved by generation of new frequencies in the UV spectral range where the output of the ZnO nanocrystals is absorbed directly by cells and subsequently stimulates photo-dissociation of specific cell bio-molecules or when radiation with new frequencies can stimulate photo-chemical interactions inside the cells compartments (such as photodynamic therapy).

Owing to the tunability of wavelength up-conversion of ZnO nanocrystals, conversion of input electromagnetic radiation in the infrared (IR) region to output electromagnetic radiation in the visible (or even ultraviolet (UV)) region as a result of the nonlinear optical phenomenon, such nanocrystals can be used in tandem with light-activated therapeutics such as photosensitizers and gold (or silver) nanoshells for photodynamic and photothermal therapies, respectively.

Photodynamic therapy and thermal ablation therapies are a new generation of treatment modalities which has significant implications in diseases such as cancer. Such therapies are advantageous from the point of view that they can be externally controlled to be triggered only at the diseased sites, as opposed to systemic toxicity that results from conventional chemo/radiation therapies. However the limited penetration of visible light through biological tissues severely hampers the applications of such therapies.

Local energy transfer between two interactive species can overcome the drawbacks related to deep-tissue accessibility of visible or UV light. The present invention, involves a species, for example ZnO nanocrystals located in a targeted site, which converts the lower energy incident laser radiation without any essential absorption (e.g. near IR(NIR)/IR region of electromagnetic radiation), to higher energy (e.g. visible or UV region of electromagnetic radiation), a phenomenon known as ‘up-conversion’. The high energy quanta are in turn transferred to another nearby species (photosensitizers) that absorbs in the higher energy (lower wavelength) regime, thus allowing the indirect activation of the visible absorbing species using NIR/IR activation—“remote control”. Since NIR/IR electromagnetic radiation is not absorbed in the medium and the energy transfer process occurs locally—in the proximity of specifically targeted species—such an energy transfer approach is safer (softer) for healthy surrounding tissue and it can greatly facilitate the efficacy of photodynamic and photothermal therapies in deep tissues.

The ZnO nanocrystal compositions of the present invention have properties that make them useful in bioimaging and therapeutic applications. The following describes some of these advantages.

The nonlinear optical properties of ZnO nanocrystals allow use of incident electromagnetic radiation that is not absorbed by the sample. Electromagnetic radiation of a longer wavelength that is in the biological transparency window can be used. Compared to one- or multi-photon excited fluorescence imaging, four-wave mixing-, second-harmonic-, and sum-frequency imaging are tunable for input-output wavelength and can be adjusted to the absorption free spectral range of both nanocrystals and specimen to avoid autofluorescence and cell damage by therapy or photochemistry.

The output electromagnetic energy is tunable in that the frequency of the nonlinear output electromagnetic energy is related to the input energy used to generate it. Thus, the desired output can be achieved by use of the appropriate input frequency or frequencies. Generally, fluorophores have a non-tunable absorption band that requires excitation at a given wavelength. The output frequencies can be manipulated to be in the desired range of optical frequencies. For therapeutic applications, the new frequency can be generated in situ to be within appropriate absorption band, which is needed for therapy (such as UV therapy, photodynamic therapy, light-activated release of drugs).

In these nonlinear frequency conversion processes, electromagnetic radiation is not absorbed, so no energy is deposited in the specimen, if these generated frequencies are in the region outside of absorption bands of the nanocrystals and the biological samples, thus making them very desirable for bioimaging and therapeutic applications.

ZnO nanocrystals have advantages resulting not only from their optical properties, but also with the biocompatibility of ZnO, which is considered to be more biocompatible than CdS quantum dots which are known to be toxic.

The following examples are provided for illustrative purposes only and are not intended to be limiting in any manner.

### EXAMPLE 1

### Preparation and Characterization of ZnO Nanocrystals

ZnO nanocrystals were synthesized using a non-hydrolytic sol-gel process based on the ester-elimination reaction between zinc acetate and 1,2-dodecanediol. The benzyl ester was selected as the solvent reagent because its high boiling point increased the synthesis temperature to 280 degrees Celsius, which provided high-quality samples with excellent size control, narrow size distribution, and uniform crystalline structure and dispersion properties. High (10 mmol) molar concentration of Zn acetate dehydrates results in supersaturation of the reaction solution and increases the yield of reaction.

### Preparation of Aqueous Dispersions of ZnO Nanocrystals

The ZnO nanocrystals were stably dispersed in distilled water using phospholipid micelles. This aqueous dispersion was achieved by mixing a chloroform solution of ZnO nanocrystals (15 mg/mL, 100 μL) and DSPE-PEG(2000) methoxy (Avanti Polar Lipids) (20 mg/mL, 500 μL), followed by removal of the chloroform by rotary evaporation resulting in a dry film. Water was added to the dry film and the composition subjected to vortex mixing resulting in an aqueous dispersion of ZnO nanocrystals. The resulting aqueous dispersion of ZnO nanocrystals was then sterile filtered for further use.

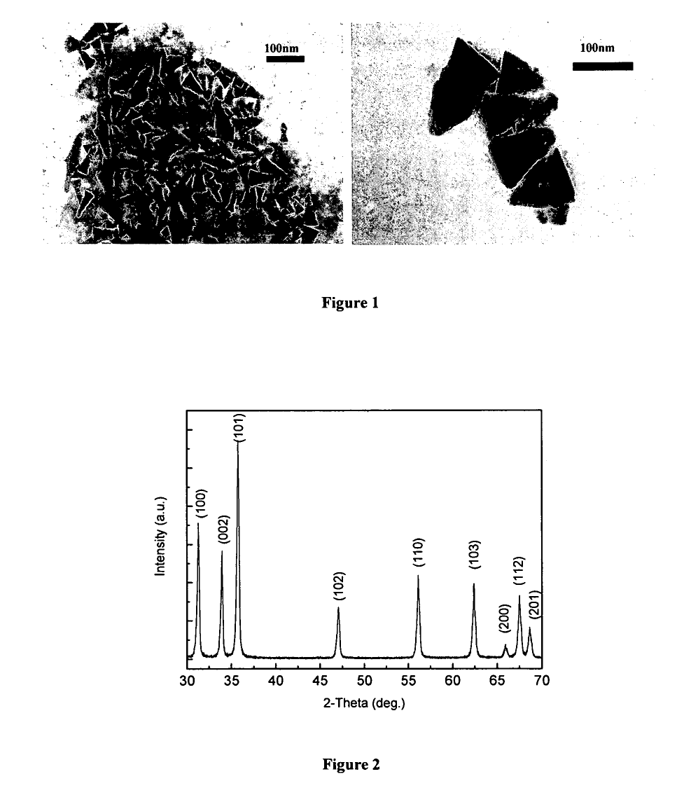

The size, compositional, structural and morphological characterization of the nanocrystals was performed by transmission electron microscopy (TEM) and by X-ray diffraction (XRD). ZnO nanocrystals with a size range of 100 nm or less and shaped as trigonal pyramids as shown by the TEM picture in FIG. 1. The crystalline structure of the ZnO nanocrystals was identified by XRD spectrum (FIG. 2) to correspond to a hexagonal unit cell (wurtzitic structure).

### EXAMPLE 2

### Imaging Using ZnO Nanocrystals

The optical setup shown in FIG. 3(b) was used to image biological samples using ZnO nanocrystals. Two picosecond lasers generated initial (input) frequencies ν₁, and ν₂. The ν₂ wave had a fixed wavelength of 1064 nm, and ν₁ wave was tunable in the 750-920 nm spectral range. Picosecond pulses with the frequencies ν₁ and ν₂ were time and space conjugated, and by means of dichroic mirrors, directed to the XY galvano-scanner and microscope. Both waves were coincidentally focused by a high numerical aperture objective on the specimen that had been contacted with a ZnO water dispersed sample. The nonlinear output waves generated in the sample at (2ν₁−ν₂), and at (ν₁+ν₂), 2 ν₁, and 2 ν₂ were collected in the backward propagation direction. They were directed to the corresponding PMT detectors by means of appropriated dichroic mirrors. Digital detection system and XY scanner were controlled by computer with appropriate software. Finally, software generated digital images formed by intensity distributed of optical signals at new frequencies (2 ν₁−ν₂), (ν₁+ν₂), 2 ν₁ and 2 ν₂ were displayed.

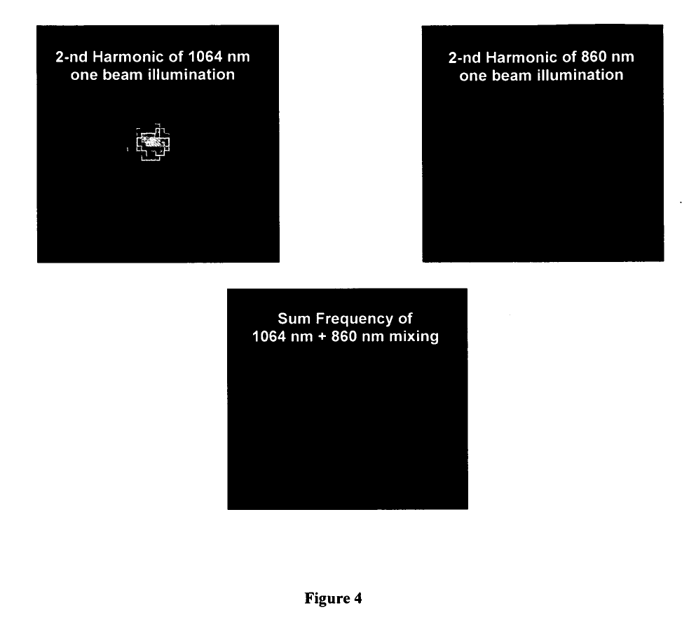

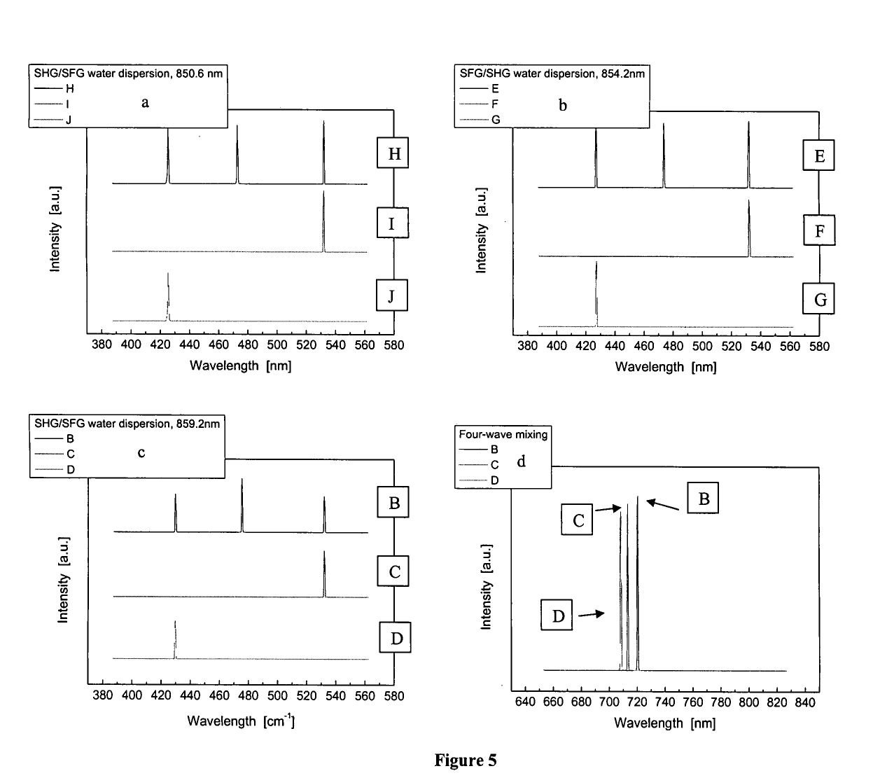

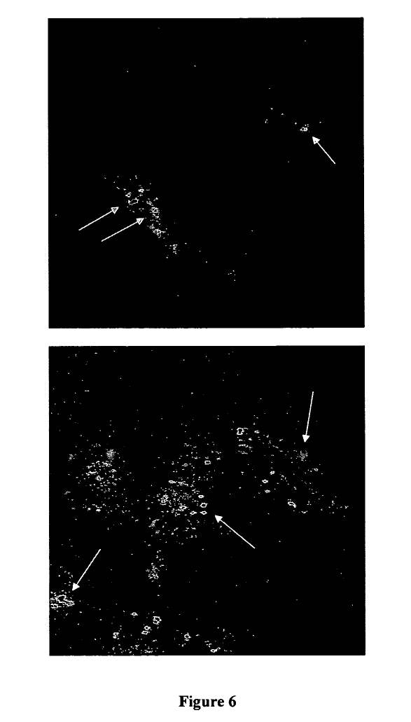

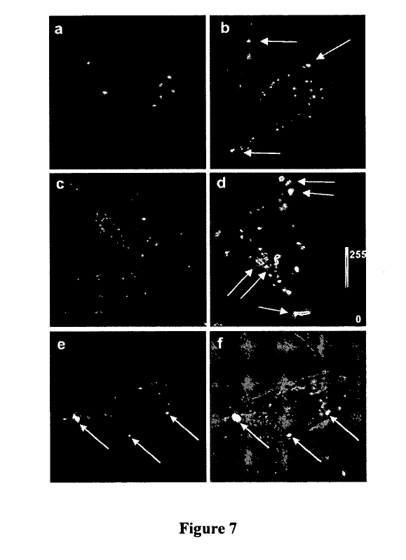

An example of the beam spots of new frequencies generated in the water-dispersed ZnO sample by ν₁=860 nm and ν₂=1064 nm and propagating in the backward direction of ν₁ and ν₂ is shown in FIG. 4. Spectral distribution of the FWM signal at (2 ν₁−ν₂), SFG signal at ν₁+ν₂, and two SHG signals at 2 ν₁ and 2 ν₂, for three different combinations of incident wavelengths of ν₁ wave (851 nm; 854 nm; 859 nm) and fixed ν₂ wave of 1064 nm are presented in FIG. 5. KB cells treated with water dispersed solution of ZnO nanocrystals was used to generate cell image of SFG output. FIG. 6 presents the overlay of a laser scan transmission (1064 nm) image (green) with SFG (475 nm) image (red in the original color image, but seen as white in the black & white picture here) reconstructed by software using intensity distributions of the transmission signal and SFG signal obtained during the laser scan of the biological specimen. In the figure, the white arrows identify the SFG image signal.

### EXAMPLE 3

### Preparation of Aqueous Dispersion of ZnO Nanocrystals for Targeted Imaging

ZnO nanocrystals were stably dispersed in distilled water using phospholipid micelles as the stabilizer. The phospholipid micelles are comprised of DSPE-PEG(2000) methoxy and DSPE-PEG(2000)-FA (Avanti Polar Lipids). ZnO nanocrystals in chloroform (17 mg/mL, 100 μL) was mixed with (a) 500 μL of DSPE-PEG(2000) methoxy (20 mg/mL in chloroform), or (b) a mixture of 480 μl of DSPE-PEG (20 mg/mL in chloroform) and 200 μL of DSPE-PEG(2000)-FA (2 mg/mL chloroform). Then chloroform was removed using a rotary vacuum evaporator and the dry film dispersed in distilled water (3 mL) by vortex mixing. The aqueous dispersion of ZnO nanocrystals was then sterile filtered prior to treatment of a biological specimen.

### EXAMPLE 4

### Preparation of Human Nasopharyngeal Epidermal Cells for Imaging Using ZnO Nanocrystals

Human nasopharyngeal epidermal carcinoma (KB) cells were used for imaging. A KB cell culture was plated overnight in an incubator in 35 mm glass bottom cell dishes in a minimum essential medium (MEMα) with 10% fetal bovine serum (FBS) and appropriate antibiotic, according to the manufacturers instructions (American Type Culture Collection). Next, with the cells at a confluency of 70%, the overnight medium was aspirated and replaced with fresh medium (2 mL/dish). To study ZnO nanocrystal uptake, the aqueous dispersion of ZnO nanocrystals (formulated with and without incorporated folic acid as described in Example 3) (200 μL) was added to the cell culture, mixed by gentle swirling, and replaced in the incubator at 37° C. with, 5% CO₂ (VWR Scientific, 2400).

### Imaging Human Nasopharyngeal Epidermal Cells Using ZnO Nanocrystals

After 1 and 3 hours of incubation, the cells were rinsed with phosphate-buffered saline (PBS) and directly imaged. The confocal SFG images of KB cells treated with the aqueous dispersion of ZnO nanocrystals and targeted ZnO-FA nanocrystals (nanocrystal composition with folic acid (FA) incorporated to target the FA receptors on the KB cells), for 1 and 3 hours, are shown in FIG. 7(a)-(d). It is observed that the non-targeted ZnO nanocrystal intracellular uptake (FIG. 7(a), (b)) is less than that observed in the case of SFG output from cells treated with ZnO-FA nanocrystals for 3 hours (FIG. 7(d)). The arrows in FIGS. 7(d) and (e) are directed at the SFG output signals. Based on the images, the nanocrystals appear to be distributed throughout the cytoplasm. The localized narrow spectrum, a laser like line, confirms that the observed SFG signal is from internalized nanocrystals. Besides SFG response, intensive FWM output was generated by ZnO nanocrystals in the forward direction of the incident beams. The corresponding images of FWM and SFG signals in the same scan are shown in FIG. 7e and FIG. 7f. There was FWM emission (arrows in FIG. 7(e)) from exactly from the same location as that where SFG signal was detected (arrows in FIG. 7(f)). However, in contrast to the SFG signals generated by ZnO nanocrystals, the FWM nonlinear response is generated both by internalized nanocrystals and cell compartment materials such as lipids, membranes, proteins, etc.

During our experiments, conducted with the maximum laser peak intensity of ˜6 GW/cm², scanning speed of ˜0.1 m/msec and scanned area ˜70×70 μm², there was no evidence of photodamage of the cells found even after 50 sequential image scans. No indication of cytotoxicity could be observed at the experimental dosage, as observed by the equal viability of ZnO treated cells and untreated cells using a cell viability (MTT) assay. This further highlights the potential of ZnO nanocrystals as non-toxic nonlinear optical probes for diagnostic imaging.

From the teachings of the present invention, those skilled in the art will recognize that various modifications and changes may be made without departing from the spirit of the invention. Such modifications are intended to be with the scope of the present invention.

1. A method for imaging a biological specimen comprising the steps of:
a. providing an aqueous dispersion comprising ZnO nanocrystals, wherein the ZnO nanocrystals comprise ZnO nanocrystals in the range of from 5 nm to 500 nm in diameter having a crystal structure based on a non-centrosymmetric space group;
b. contacting the biological specimen with the aqueous dispersion;
c. exposing the biological specimen to input electromagnetic radiation, wherein the electromagnetic radiation has a wavelength of 600 nm to 1500 nm;
d. recording the nonlinear output electromagnetic radiation from the biological specimen; and
e. generating an image of the biological specimen from the nonlinear output electromagnetic radiation.

2. The method of claim 1 wherein the ZnO nanocrystals are 100 nm or less in size.

3. The method of claim 2 wherein the ZnO nanocrystals are from 50 nm to 100 nm in size.

4. The method of claim 1 wherein 70, 75, 80, 85, 90, 91, 92, 93, 94, 95, 96, 97, 98, 99 or 100 percent of the ZnO nanocrystals are in the range of from 5 nm to 500 nm in diameter.

5. The method of claim 1 wherein the ZnO nanocrystals are incorporated into or within a surrounding layer, wherein the surrounding layer completely or partially surrounds the ZnO nanocrystals.

6. The method of claim 5 wherein the surrounding layer comprises a phospholipid.

7. The method of claim 6 wherein the phospholipid comprises (1,2-distearoyl-sn-glycero-3-phosphoethanolamine-N—[methoxy(polyethylene glycol)-2000] (ammonium salt) (DSPE-PEG(2000) methoxy).

8. The method of claim 6 wherein the phospholipid comprises 1,2-distearoyl-sn-glycero-3-phosphoethanolamine-N—[folate(polyethylene glycol)-2000] (ammonium salt) (DSPE-PEG(2000)-FA).

9. The method of claim 5 wherein the surrounding layer comprises an affinity molecule incorporated therein or attached thereto, wherein the affinity molecule has specific affinity for another molecule in the biological specimen.

10. The method of claim 1 wherein the source of the input electromagnetic radiation is a laser.

11. The method of claim 1 wherein the wavelength range of the input electromagnetic radiation is 800 nm to 1300 nm.

12. The method of claim 1, wherein the input electromagnetic radiation comprises one wavelength.

13. The method of claim 1 wherein the input electromagnetic radiation comprises two wavelengths.

14. The method of claim 12 wherein the wavelength of input electromagnetic radiation is selected from the group consisting of 851 nm, 854 nm, 859 nm, and 1064 nm.

15. The method of claim 13 wherein the wavelengths of input electromagnetic radiation are selected from the group consisting of 851 nm, 854 nm, 859 nm, and 1064 nm.

16. The method of claim 1 wherein the nonlinear output electromagnetic radiation is selected from the group consisting of second-harmonic generation signal, sum frequency generation signal, four-wave mixing signal, or combinations thereof.
